(19) United States
(12) Patent Application Publication
(10) Pub. No.: US 2026/0303696 A1
(43) Pub. Date: Oct. 1, 2026

(54) COMMUNICATION SEND TIME PREDICTION IN PREDICTIVE TRAIT SYSTEMS

(71) Applicant: Twilio Inc., SAn Francisco, CA (US)

(72) Inventors: Maria del Pilar Fernandez Gallego, Madrid (ES); Ankit Awasthi, San Franicsco, CA (US)

(21) Appl. No.: 19/094,725

(22) Filed: Mar. 28, 2025

(51) Int. Cl. H04L 67/306; H04L 67/00

(52) U.S. Cl. CPC H04L 67/306; H04L 67/34

(57) ABSTRACT

A system and method including accessing, for each user of a set of users, user activity data representing one or more user events; processing the user activity data to generate processed activity data; estimating, for each user of the set of users, an active period model based on the processed user activity data and a constraint configuration; computing, for each user of the set of users and using the corresponding estimated active period model for the user, activity scores for candidate time periods; selecting, for each user of the set of users, at least one time period of the candidate time periods based on the corresponding activity scores for the user, and transmitting, for each user of the users, a communication to the user during a corresponding selected time period.

### TECHNICAL FIELD

The disclosed subject matter relates generally to the technical field of prediction systems and, in one specific example, to predicting send times for communications in a predictive trait system.

### BACKGROUND

Businesses and organizations face significant technical challenges in today's complex digital landscape, for instance with respect to optimal timing of messages being sent to users in the context of business-user interactions. Recent communication scheduling solutions use machine learning models with a variety of features, relying on generic prediction frameworks that can be applied to a variety of user-level prediction tasks, but that fall short in the case of predicting time-related variables. Therefore, the problem of best choosing time intervals for sending communications to specific users remains open.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of example, and not limitation, in the figures of the accompanying drawings.

FIG. 1 is a network diagram illustrating a system within which various example embodiments may be deployed.

FIG. 2 is a diagrammatic representation of a communication scheduling system, according to some examples.

FIG. 3 is an illustration of views of a histogram, periodic mean hour and estimated active period model for a user's activity history, according to some examples.

FIG. 4 is an illustration of views of a histogram, periodic mean hour and estimated active period model for a user's activity history, according to some examples.

FIG. 5 is an illustration of views of histograms, a periodic mean hour and an estimated active period model for a set of user activities associated with a target customer, according to some examples.

FIG. 6 is an illustration of views of histograms, a periodic mean hour and an estimated active period model for a set of user activities associated with a target customer, according to some examples.

FIG. 7 is an illustration of views of histograms, a periodic mean hour and an estimated active period model for a set of user activities associated with a target customer, according to some examples.

FIG. 8 is an illustration of views of histograms, a periodic mean hour and an estimated active period model for a set of user activities associated with a target customer, according to some examples.

FIG. 9 is an illustration of views of histograms, a periodic mean hour and an estimated active period model for a set of user activities associated with a target customer, according to some examples.

FIG. 10 is a block diagram illustrating a view of a predictive trait system that includes a framework for training, evaluating, or deploying trait prediction models, according to some examples.

FIG. 11 is a block diagram illustrating a view of a predictive trait system, according to some examples.

FIG. 12 is an illustration of a view of a user interface (UI) for a predictive trait system, according to some examples.

FIG. 13 is an illustration of a visualization of data related to trait prediction results within a UI for a predictive trait system, according to some examples.

FIG. 14 is a block diagram illustrating an example of a software architecture that may be installed on a machine, according to some examples.

FIG. 15 is a block diagram illustrating components of a machine, according to some example embodiments, able to read instructions from a machine-readable medium (e.g., a machine-readable storage medium) and perform any one or more of the methodologies discussed herein.

FIG. 16 is a block diagram showing a machine-learning (ML) program, according to some examples.

### DETAILED DESCRIPTION

Businesses and organizations face significant challenges in determining how to effectively implement and deliver marketing and email campaigns across complex digital systems. For example, businesses invest substantial resources and effort in creating personalized messages, developing timely product offers, and/or building systems to deliver customized user experiences. However, these efforts also need a high-quality communication scheduling solution—in its absence, communications may be delivered when users are less likely to engage with them. Current communication scheduling solutions use machine learning (ML) models and a variety of features to compute send times or time periods for business or marketer communications. However, current solutions treat send time prediction similarly to predicting other user-related features, without explicitly taking into account specific characteristics and/or constraints of time-related variables, such as the 24 hour cycle in a day, the periodic behavior of a time variable, and so forth. As a result, the performance of current solutions needs further improvement. Therefore, the problem of computing highly accurate user-specific time intervals for sending communications remains open.

Examples in the disclosure herein refer to a communication scheduling system that automatically builds active period models for users based on their historical activity patterns and/or one or more specified constraints. The communication scheduling system uses the active period models to determine one or more candidate time periods when users are most likely to be active and/or potentially receptive to engaging with a communication, such as an e-mail, a SMS, and so forth. In some examples, the communication scheduling system accesses, for each user of a set of users, user activity data representing one or more timestamped user events (e.g., page views, email opens, clicks, and so forth). The system processes the user activity data using a constraint configuration and/or activity quantity requirements, thus generating processed user activity data. The constraint configuration can specify data quantity requirements and/or data selection requirements. In some examples, the constraint configuration includes time period inclusion and/or exclusion properties or requirements. In some examples, the activity quantity requirements include a predetermined minimum period of user activity, a predetermined maximum period of user activity, a predetermined minimum number of user events, or other requirements. In some examples, processing the user activity data further includes filtering out user events corresponding to communications detected to be opened by proxy servers.

In some examples, the communication scheduling system trains or estimates an active period model based on the processed user activity data for the user. In some examples, estimating the active period model includes selecting a distribution and/or a distribution type based on one or more constraints in the constraint configuration, and/or computing one or more parameters of the selected distribution based on the processed user activity data. In some examples, the one or more constraints can include time variable-associated constraints, such as a cyclical time constraint for hours in a day. In some examples, the selected distribution is a von Mises distribution. The distribution parameters can include a location parameter corresponding to a periodic mean, and/or a shape parameter indicating a concentration of data around the periodic mean. In some examples, the communication scheduling system selects a kernel density estimation technique with a kernel function (e.g., a von Mises distribution kernel, etc.), estimating a probability density function as a sum of kernel functions centered at data points of the processed user activity data.

Given a candidate time period, the communication scheduling system can use the trained and/or estimated active period model to compute an activity score associated with the candidate time period for a given user. For example, the activity score can correspond to a predicted probability that the user is likely to be active during the candidate time period and/or likely to engage with a communication (e.g., e-mail, SMS, and so forth) received during the respective time period. In some examples, computing the predicted probability uses the selected distribution and/or estimated parameters. In some examples, the communication scheduling system computes activity scores for a set of candidate time periods for the given user and/or ranks the activity scores based on a predetermined criterion (e.g., preferring higher values to lower values). The communication scheduling system can select a set of top K candidate time periods based on their associated scores (K=constant, K>=1). Given a selected candidate time period, the communication scheduling system can select a communication of interest and send a communication to the user during the selected candidate time period. Candidate time periods correspond, for example, to hour-long intervals of a 24-hour period, and so forth.

In some examples, the communication scheduling system is a component and/or subsystem of a predictive trait system comprising a predictive trait user interface (UI). Responsive to detecting, at the predictive trait UI, a selection of a predictive trait corresponding to predicting suitable time periods for communicating with a customer's users, the communication scheduling system accesses user activity data and/or proceeds with estimating one or more active period models based on the user activity data. The communication scheduling system computes predictive trait values by predicting the most suitable per-user time periods for sending communications. In some examples, the predictive trait system and/or communication scheduling system display, at the predictive trait UI, one or more explanations computed based on one or more of at least the computed predictive trait values and the set of users. Such explanations can include a visualization of computed predictive trait values (e.g., most likely or most suitable time periods for communication scheduling and/or delivery), a visualization of the parameters or fit of the estimated active period model for one or more users, and so forth.

Overall, the communication scheduling system disclosed herein mitigates technical challenges around determining send times for communications to users. Current communication scheduling solutions fail to properly account for the cyclical nature of time variables, while the disclosed system addresses these limitations through automatically constructing period-level activity models based on user historical patterns and/or explicitly incorporating time-specific characteristics like daily cycles. By using specialized components for constraint processing and active period estimation, along with specialized statistical techniques, the communication scheduling system and/or a larger predictive trait system enable prediction of well-timed communication delivery windows to improve the chances of user engagement.

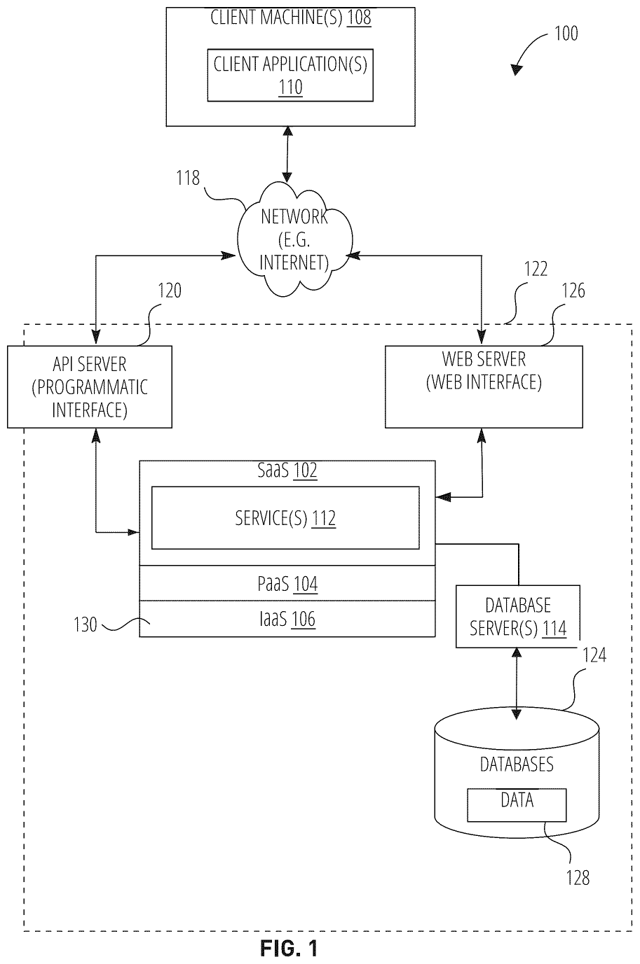

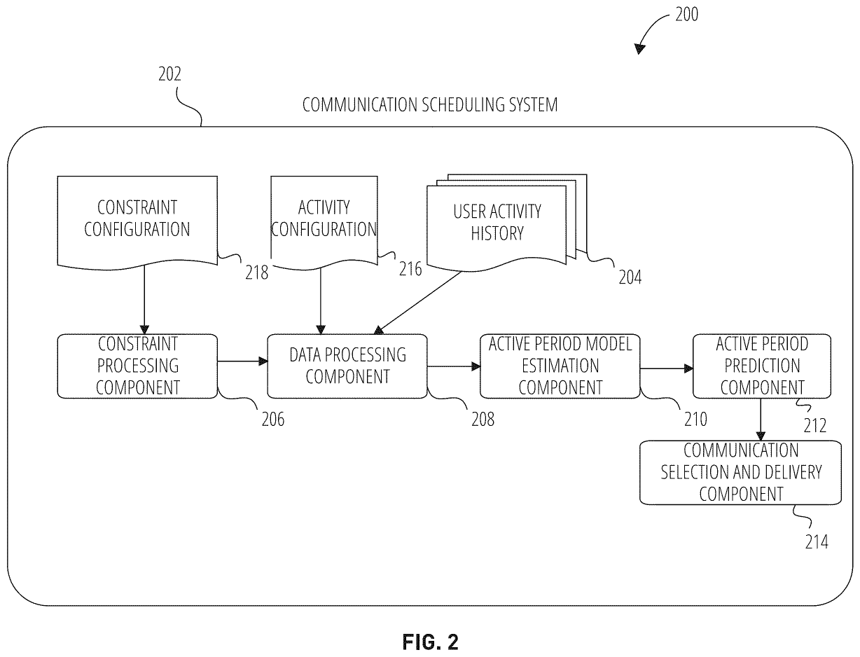

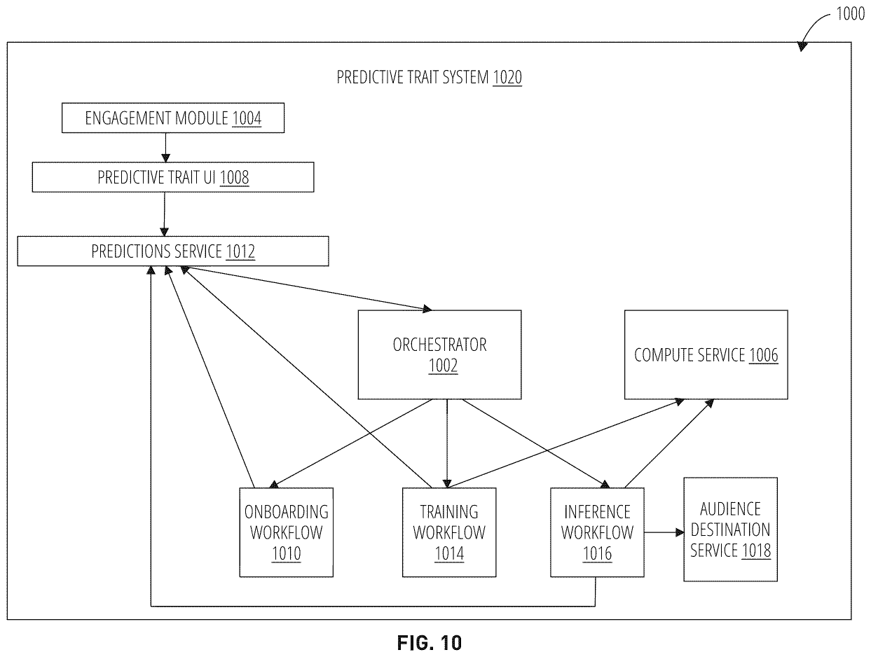

FIG. 1 is a network diagram depicting a system 100 within which various example embodiments may be deployed (such as a communication scheduling system 202 illustrated in FIG. 2, or a predictive trait system 1020 in FIG. 10). A networked system 122 in the example form of a cloud computing service, such as Microsoft Azure or other cloud service, provides server-side functionality, via a network 118 (e.g., the Internet or Wide Area Network (WAN)) to one or more endpoints (e.g., client machine(s) 108). FIG. 1 illustrates client application(s) 110 on the client machine(s) 108. Examples of client application(s) 110 may include a web browser application, such as the Internet Explorer browser developed by Microsoft Corporation of Redmond, Washington or other applications supported by an operating system of the device, such as applications supported by Windows, iOS or Android operating systems. Examples of such applications include e-mail client applications executing natively on the device, such as an Apple Mail client application executing on an iOS device, a Microsoft Outlook client application executing on a Microsoft Windows device, or a Gmail client application executing on an Android device. Examples of other such applications may include calendar applications, file sharing applications, and contact center applications. Each of the client application(s) 110 may include a software application module (e.g., a plug-in, add-in, or macro) that adds a specific service or feature to the application.

An API server 120 and a web server 126 are coupled to, and provide programmatic and web interfaces respectively to, one or more software services, which may be hosted on a software-as-a-service (SaaS) layer or platform 102. The SaaS platform may be part of a service-oriented architecture, being stacked upon a platform-as-a-service (PaaS) layer 104 which, may be, in turn, stacked upon a infrastructure-as-a-service (IaaS) layer 106 (e.g., in accordance with standards defined by the National Institute of Standards and Technology (NIST)).

While the applications (e.g., service(s)) 112 are shown in FIG. 1 to form part of the networked system 122, in alternative embodiments, the applications 112 may form part of a service that is separate and distinct from the networked system 122.

Further, while the system 100 shown in FIG. 1 employs a cloud-based architecture, various embodiments are, of course, not limited to such an architecture, and could equally well find application in a client-server, distributed, or peer-to-peer system, for example. The various server applications 112 could also be implemented as standalone software programs. Additionally, although FIG. 1 depicts machines 108 as being coupled to a single networked system 122, it will be readily apparent to one skilled in the art that client machine(s) 108, as well as client applications 110, may be coupled to multiple networked systems, such as payment applications associated with multiple payment processors or acquiring banks (e.g., PayPal, Visa, MasterCard, and American Express).

Web applications executing on the client machine(s) 108 may access the various applications 112 via the web interface supported by the web server 126. Similarly, native applications executing on the client machine(s) 108 may access the various services and functions provided by the applications 112 via the programmatic interface provided by the API server 120. For example, the third-party applications may, utilizing information retrieved from the networked system 122, support one or more features or functions on a website hosted by the third party. The third-party website may, for example, provide one or more promotional, marketplace or payment functions that are integrated into or supported by relevant applications of the networked system 122.

The server applications 112 may be hosted on dedicated or shared server machines (not shown) that are communicatively coupled to enable communications between server machines. The server applications 112 themselves are communicatively coupled (e.g., via appropriate interfaces) to each other and to various data sources, so as to allow information to be passed between the server applications 112 and so as to allow the server applications 112 to share and access common data. The server applications 112 may furthermore access one or more databases 124 via the database servers 114. In example embodiments, various data items are stored in the databases 124, such as the system's data items 128. In example embodiments, the system's data items may be any of the data items described herein.

Navigation of the networked system 122 may be facilitated by one or more navigation applications. For example, a search application (as an example of a navigation application) may enable keyword searches of data items included in the one or more databases 124 associated with the networked system 122. A client application may allow users to access the system's data items 128 (e.g., via one or more client applications). Various other navigation applications may be provided to supplement the search and browsing applications.

FIG. 2 is a diagrammatic representation 200 of a communication scheduling system 202, according to some examples. The communication scheduling system 202 includes one or more of at least a user activity history 204, a constraint processing component 206, a data processing component 208, an active period model estimation component 210, an active period prediction component 212, a communication selection and delivery component 214, an activity configuration 216, and a constraint configuration 218.

In some examples, the communication scheduling system 202 employs user activity history 204, constraint configuration 218 and/or activity configuration 216 to automatically build and/or estimate, using the active period model estimation component 210, an active period model (e.g., a model of period-based activity) for the given user and a set of periods. In some examples, the periods can correspond to hourly intervals (e.g., one or more of the 24 hours in a day), or to other predetermined length time intervals. Given an active period model and a target period, the active period prediction component 212 can compute an activity score indicating how likely a user is to be active during the target period. Given a set of candidate periods, communication scheduling system 202 can select, based on the predicted activity scores, one or more candidate periods for communicating with the user via one or more communications selected and/or delivered by the communication selection and delivery component 214.

In some examples, the communication scheduling system 202 accesses or includes a constraint configuration 218. The constraint configuration 218 can be authored or modified by a developer, data scientists, marketer, and so forth, either via an API or via a user interface (UI) of the communication scheduling system 202 (e.g., an API or a UI of constraint processing component 206). The constraint configuration 218 can include one or more constraints of interest, such as inclusion and/or exclusion properties associated with time periods (e.g., excluding certain hours in a day from communication scheduling, etc.), relationships among time periods (e.g., a cyclical data constraint or circular data constraint indicating that the end of a time period ending at 24:00 on day D coincides with the beginning of a time period beginning at 00:00 on day D+1), a constraint specifying that the value of a variable of interest is higher—or lower—during hour X of a weekend than during hour X of a week, a constraint specifying that the value of a variable of interest is higher- or lower-during hour X of month Y than during hour X of month Z, and so forth.

In some examples, the communication scheduling system 202 accesses or includes an activity configuration 216. The activity configuration 216 can be automatically updated via an API or a UI of the communication scheduling system 202 (e.g., of the data processing component 208) based on input received from a customer business, a developer, a marketer, and so forth. In some examples, for a customer, the activity configuration 216 includes data representing user event and/or action descriptors (e.g., user event types, user event names, user event description fields, etc.) corresponding to user events whose occurrence during a time period indicates that the user was active during the respective time period. Example user event descriptors include user event types such as “page_viewed,” “email_opened,” “email_delivered,” “email_link_clicked,” “sms_delivered,” “sms_link_clicked,” and so forth. In some examples, the activity configuration 216 data can also include activity quantity requirements such as a predetermined minimum period of user activity per user (e.g., 1 month of relevant user events and/or user actions), a predetermined maximum period of user activity per user (e.g., 6 months of relevant user events and/or actions), a predetermined minimum number of user events and/or actions per user (e.g., 30 user events, etc.), and so forth.

As indicated above, the communication scheduling system 202 schedules communications for a customer (e.g., customer business or organization) and for a set of users associated with the customer. The data processing component 208 accesses or receives user data such as user activity history 204. User activity history 204 can include user events and/or actions for one or more users in the set of users associated with the specific customer. Each entry in the user activity history 204 can include, for example, data fields representing:
a user ID
a user event/and or action (e.g., an occurrence of a “page_viewed”-type event for a specific page)
a time stamp associated with the user event and/or action (e.g., “2022 Oct. 12 07:15:30”, etc.),
a data field whose value indicates whether a particular communication has been automatically opened by a proxy server (e.g., a “prop_useragent” field whose value may contain “proxy” to indicate, for example, that an e-mail was opened by a proxy server, such as a Google or Apple proxy server), and so forth. In some examples, the user activity history 204 data is stored across multiple event tables associated with the customer, each event table corresponding to a user event descriptor (e.g., a “email_opened” event table for users of the customer, a “page_viewed” event table for users of the customer, and so forth).

Given each target user in the set of users for the customer, the data processing component 208 retrieves the entries of the user activity history 204 corresponding to user events or/actions of the target user. In some examples, the entries are filtered to retain user events and/or actions matching one or more of the user event descriptors in the activity configuration 216 for the customer. For example, user events corresponding to “page_viewed”, “email_opened”, and/or other user event descriptors can all be included in the filtered user activity data. In some examples, the set of user event descriptors can include a single user event descriptor (e.g., “page_viewed,” etc.), in which case only user events corespon ding to the user event descriptor (e.g., “page_viewed” events) are selected and included in the filtered user activity data.

In some examples, the data processing component 208 automatically filters out entries for user events corresponding to communications automatically opened by a proxy server (e.g., by filtering out entries where the value of the “prop_useragent” field includes the word “proxy”, etc.). In some examples, the retained entries for each user are used to generate filtered user activity data, each entry in the filtered user activity data including data fields such as a user ID, a user event/action, a time stamp associated with the user event and/or action, and so forth. In some examples, the filtered user activity data can omit the user event/action field and only retain the time stamp—for example, all occurrences of user events whose descriptors are included in the activity configuration 216 are treated as indicators of the user being active at a time indicated by the timestamp. In some examples, the communication scheduling system 202 can determine whether the filtered user activity data for the user meets the set of activity quantity requirements described above. If it does, the filtered user activity data can be further used by the communication scheduling system 202 for estimating an active period model for the user. If it does not, the communication scheduling system 202 will not proceed with the filtered user activity data for the user and therefore decline to estimate an active period model. In the latter case, the communication scheduling system 202 indicates that the target user does not have sufficient data for determining a communication schedule and/or send time (or send period).

Given a set of filtered user activity data for a target user, the data processing component 208 can further process the data for the purposes of model estimation based on the constraint configuration 218. For example, if the constraint configuration 218 includes a cyclical data constraint for time data, the data processing component 208 automatically converts the time stamps associated with user events to radians, taking into account a predetermined granularity indicated by a pre-specified time interval (e.g., hour, day, week, month, etc.). For example, the data processing component 208 may map a particular time stamp for a user event to the corresponding 1 hour time period of a 24 hour cycle before converting it into radians.

In some examples, given the filtered and/or processed user activity data for the target user and/or the constraint configuration 218, the active period model estimation component 210 selects a distribution suitable for estimating user activity per period and estimates the relevant parameters of the distribution, as seen below.

### Estimating an Active Period Model Using a Von Mises Distribution

In some examples, if the constraint configuration 218 data includes the cyclical or circular data constraint for time data, the active period model estimation component 210 can select a von Mises distribution (e.g., a circular normal distribution) with a corresponding probability density function (pdf)

$$p ( x ) = \frac{{e}^{k cos ( x - μ )}}{2 π {I}_{0} ( k )} ,$$

where: x is an active period random variable, μ is a location parameter (e.g., a periodic mean), k is a shape parameter (e.g., a concentration parameter controlling the concentration of the data around μ), and I₀(k) is a modified Bessel function with order 0, defined as

$${I}_{0} ( k ) = {\sum }_{i = 0}^{∞} \frac{{k}^{2 i}}{{2}^{2 i} {( i ! )}^{2}} .$$

In some examples, given a dataset D containing N times for user events and/or actions in the filtered user activity data for the target user, estimating an active period model for the user corresponds to computing the parameters of the von Mises pdf based on D. In some examples, the periodic mean u and shape parameter k can be computed as seen below:

$$μ = 2 * {tan}^{- 1} \frac{{\sum }_{{t}_{j} i n D} sin ( {t}_{j} )}{\sqrt{{( {\sum }_{{t}_{j} i n D} cos ( {t}_{j} ) )}^{2} + ( {\sum }_{{t}_{j} i n D} {sin ( {t}_{j} )}^{2} + ( {\sum }_{{t}_{j} i n D} cos ( {t}_{j} ) )}}$$

k=1/σ, σ being the standard deviation computed as:

$$σ = \sqrt{ln \frac{1}{{( \frac{1}{N} {\sum }_{{t}_{j} i n D} sin ( {t}_{j} ) )}^{2} + {( \frac{1}{N} {\sum }_{{t}_{j} i n D} cos ( {t}_{j} ) )}^{2}}}$$

### Estimating an Active Period Model Using a Von Mises Kernel

In some examples, the filtered and/or processed user activity data for the user may have multiple peaks. To accommodate such scenarios, the active period model estimation component 210 can select a kernel density estimation technique (KDE) with a specific selected kernel function such as a von Mises function. The KDE technique can estimate an active period model corresponding to a pdf p(x) of a target random variable as a sum of a set of kernel functions (e.g., von Mises kernel functions), each kernel function centered at each data point of a set of data points (e.g., set D, as above).

Given an estimated active period model for the target user and a candidate period for potential communication scheduling, the active period prediction component 212 can use the estimated model to compute an activity score for the candidate period as a probability that the candidate period will be an active period for the target user. In some examples, the active period prediction component 212 can compute activity scores as active period probabilities for a set of candidate periods. The communication scheduling system 202 can select the candidate period with the highest associated activity score as a period during which a communication to the target user should be scheduled. In some examples, the system can select a set of K periods with the highest associated activity scores as periods during which a communication to the target user should be scheduled (K>1).

In some examples, the communication scheduling system 202 estimates an active period model for each target user of the set of users for a selected customer. In some examples, the communication scheduling system 202 estimates an active period model for a subset of the set of users (or for the entire set of users) for the customer. For example, the communication scheduling system 202 can automatically aggregate the user activity data for each subset of users that meet one or more pre-determined criteria (e.g., criteria specified in the constraint configuration 218 data, and/or processed by the constraint configuration 218). For example, if users are associated with time zone information, user activity data for a subset of users of the customer that meet the criterion of being in the same time zone can be automatically aggregated and/or processed by the communication scheduling system 202 (e.g., via the data processing component 208, etc.). The communication scheduling system 202 can use the processed aggregated user activity data to estimate a time zone-specific active period model. Given a candidate period of interest, the time-zone specific active period model can be used to compute a probability that a user in the respective time zone is likely to be active during the respective period (e.g., where the user may be any user in the respective time zone). Using a time zone-specific active period model (or other aggregated active period models) enables the communication scheduling system 202 to make a prediction for a new user of the given customer, or for a user of the given customer with sparse activity data. In some examples, given a user U and candidate period C, the communication scheduling system 202 can use a prediction made by an aggregated active period model for U and C and/or a prediction made by a user-specific active period model for U and C (e.g., a U-specific active period model) to compute a final prediction for U and C. In some examples, the respective predictions can be combined using one or more combination functions known in the art (e.g., weighted linear combination, etc.).

Given a candidate period selected for sending a communication as described above, the communication selection and delivery component 214 can select one or more communications from a communication database and/or receive one or more communications from an API. In some examples, the selected and/or received one or more communications match the types of user events included in the user activity data used to estimate the active period model used to score the selected candidate period. For example, a candidate period selected based on its activity score computed by an active period model estimated using “page_viewed” user events data can be used by the communication scheduling system 202 to send communication(s) including a specific page and/or URL. A selected candidate period whose activity score was computed using an active period model estimated based on user events data representing multiple event types (e.g., “page_viewed”, “e-mail_opened”, etc.) can be used by the communication scheduling system 202 to send communication(s) matching any of the respective event types (e.g., a page and/or URL, an e-mail, etc.).

In some examples, the communication scheduling system 202 can send the selected one or more communications to the user via one or more selected communication channels.

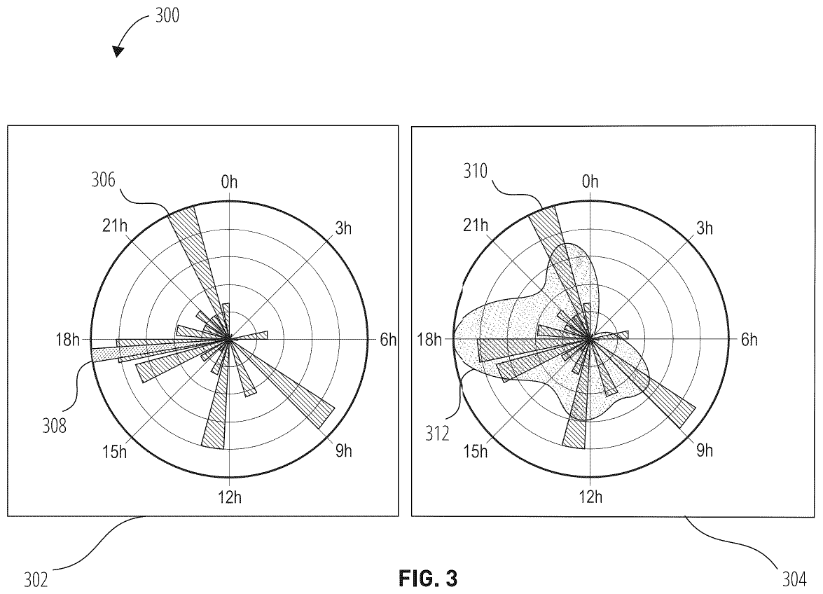

FIG. 3 is an illustration 300 of views of a histogram, periodic mean hour and estimated active period model for a user's activity history, as generated by the communication scheduling system 202, according to some examples. In the FIG. 3 example, the communication scheduling system 202 generates processed user activity data for a target user U, the processed user activity data including 564 user events from a 1-month time period (July 2022). The arithmetic mean based on user event time stamps is 2023 Jul. 10 23:14:33.051865600. The communication scheduling system 202 converts the user event time stamps to radians, as described in FIG. 2 (the period of interest here is hour-length). Panel 302 in FIG. 3 shows a histogram 306 illustrating the number of user events falling within each period of interest (e.g., each 1 hour period of the 24 hours). Panel 302 in FIG. 3 also shows the periodic mean hour estimate 308, computed as described in FIG. 2. As seen in panel 302, the periodic mean hour estimate is a better estimate of the data than the arithmetic mean estimate above, which does not take into account the circular nature of the underlying time data. Panel 304 in FIG. 3 illustrates, in addition to the same histogram of user events (e.g., 310), a plot 312 of an active period model using a von Mises distribution kernel, the plot 312 being superimposed onto the histogram 310. The model is estimated based on the user activity data as described in FIG. 2. As can be seen in panel 304, there is qualitative evidence that the estimated model effectively characterizes the user activity data.

Given the estimated active period model, the communication scheduling system 202 computes and/or outputs the probability of a particular period being a period during which the target user is likely to be active. Example computed probabilities for hourly periods in a 24 hour interval are listed below. As can be seen, [17.00-18.00] and [18.00-19.00] are the second and first most likely periods to see the target user being active, and the communication scheduling system 202 can send a selected communication to the user during one of these periods (e.g., during the first most likely active period of [18.00-19.00]).

| | |
|---|---|
| 23:00-00:00 | 0.702309 |
| 00.00-01:00 | 0.482975 |
| 01.00-02:00 | 0.206526 |
| 02.00-03:00 | 0.059934 |
| 03:00-04:00 | 0.035389 |
| 04.00-05:00 | 0.073890 |
| 05.00-06:00 | 0.156773 |
| 06.00-07:00 | 0.242731 |
| 07.00-08:00 | 0.355328 |
| 08.00-09:00 | 0.508692 |
| 09.00-10:00 | 0.535959 |
| 10.00-11:00 | 0.495829 |
| 11.00-12:00 | 0.538227 |
| 12.00-13:00 | 0.595224 |
| 13.00-14:00 | 0.555819 |
| 14.00-15:00 | 0.464245 |
| 15.00-16:00 | 0.472641 |
| 16.00-17:00 | 0.658075 |
| 17.00-18:00 | 0.928241 |
| 18.00-19:00 | 0.985202 |
| 19.00-20:00 | 0.773038 |
| 20.00-21:00 | 0.553136 |
| 21.00-22:00 | 0.499669 |
| 22.00-23:00 | 0.644880 |

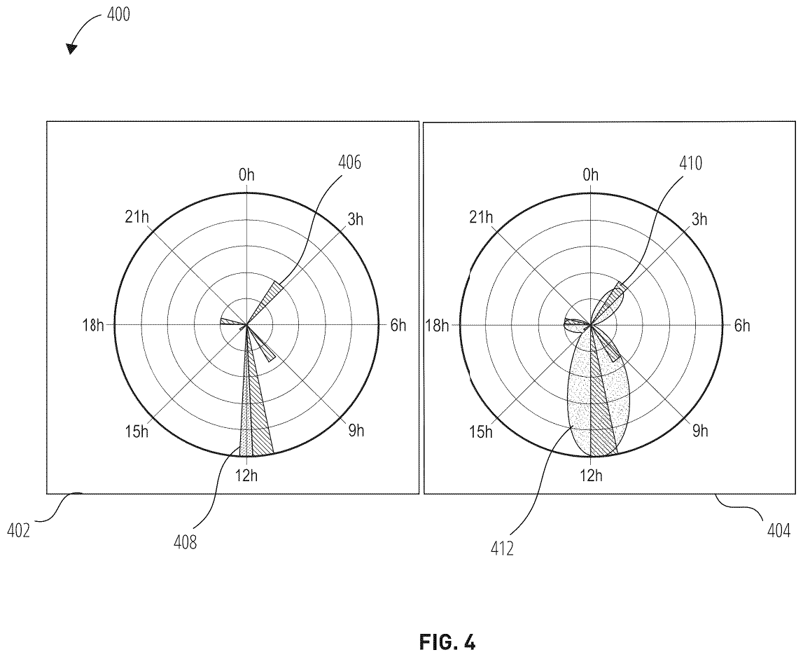

FIG. 4 is an illustration 400 of views of a histogram, periodic mean hour and active period model estimation for a user's activity history, as generated by the communication scheduling system 202, according to some examples. In the FIG. 4 example, the communication scheduling system 202 generates processed user activity data for a target user U, the processed user activity data including 30 user events from a 39 day period in 2023. The arithmetic mean based on user event time stamps is 2023 Jun. 18 23:18:09.047433216. The communication scheduling system 202 converts the user event time stamps to radians, as described in FIG. 2 (periods of interest here are hour-long periods). Panel 402 includes a histogram 406 illustrating the number of user events falling within each period of interest (e.g., each 1 hour period of the 24 hours). Panel 402 also shows the periodic mean hour 408, computed as described in FIG. 2, which is a better estimate of the data than the arithmetic mean estimate above that does not take into account the circular nature of the underlying time data. Panel 404 illustrates, in addition to the histogram 410 (e.g., same as histogram 406 of panel 402), a plot 412 of an active period model using a von Mises distribution kernel, the plot being superimposed onto the histogram. The model is estimated based on the user activity data as described in FIG. 2. As can be seen in panel 404, there is qualitative evidence that the estimated model effectively characterizes the user activity data.

Given the estimated active period model, the communication scheduling system 202 generates a probability of a particular period being a period during which the target user is likely to be active. Given 24 hourly periods in a day, periods [12:00-13:00] and [11:00-12:00] have associated probabilities 0.962167 and 0.941153, corresponding to the most likely periods of activity for the target user. The communication scheduling system 202 can send a selected communication to the user during one of these periods (e.g., during the first most likely active period of [12.00-13:00]).

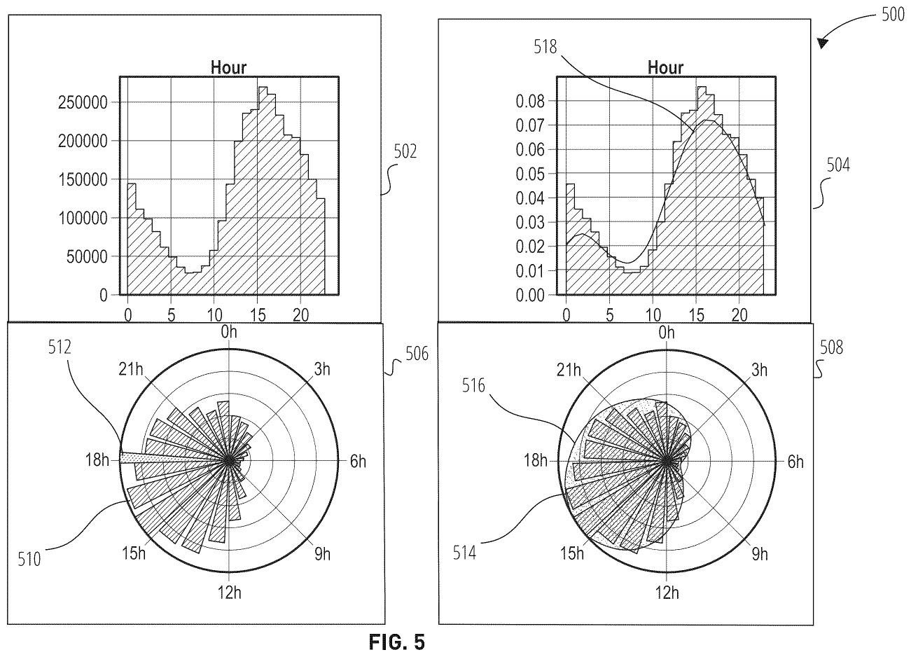

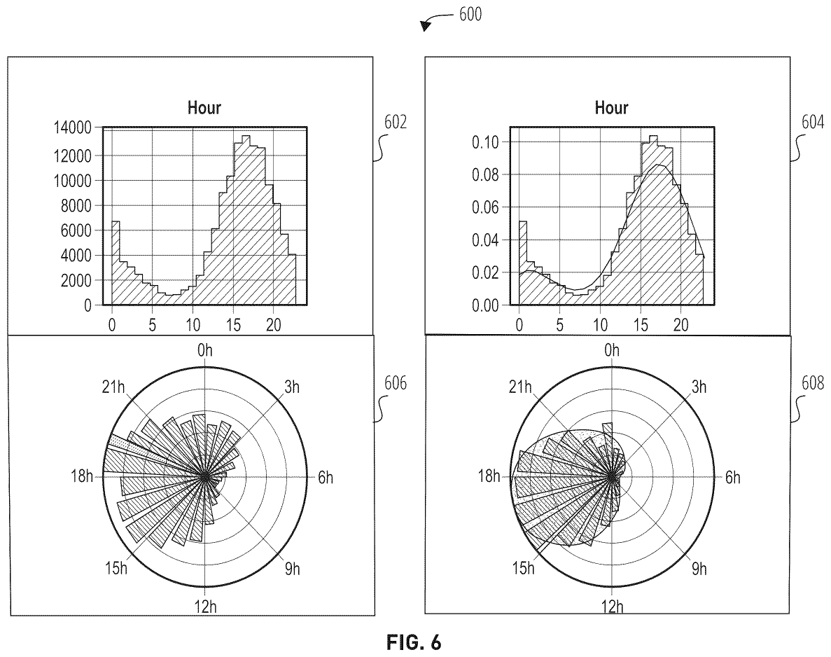

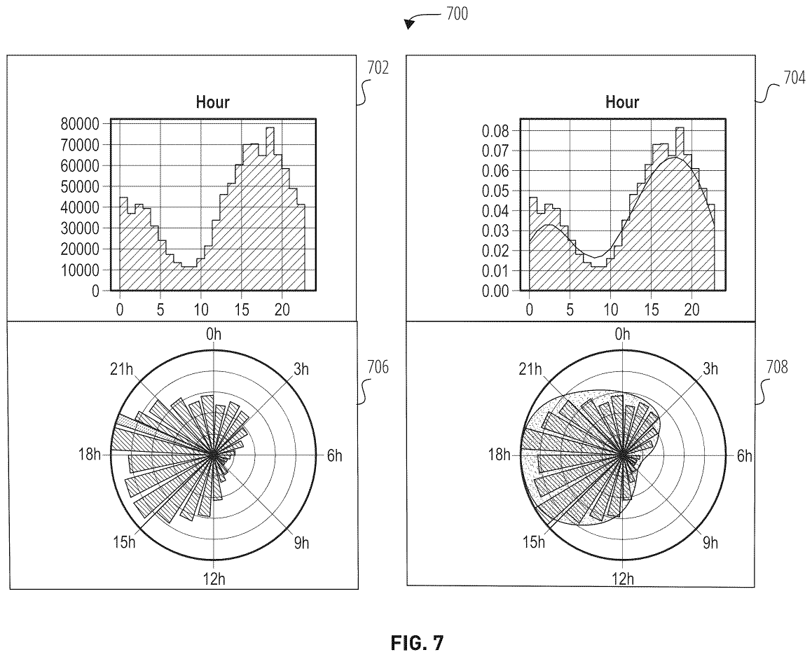

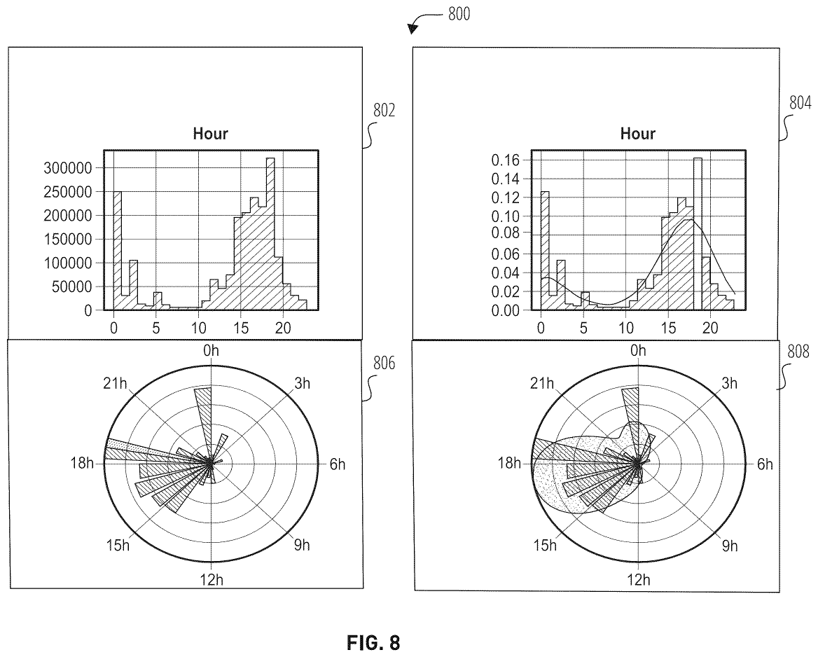

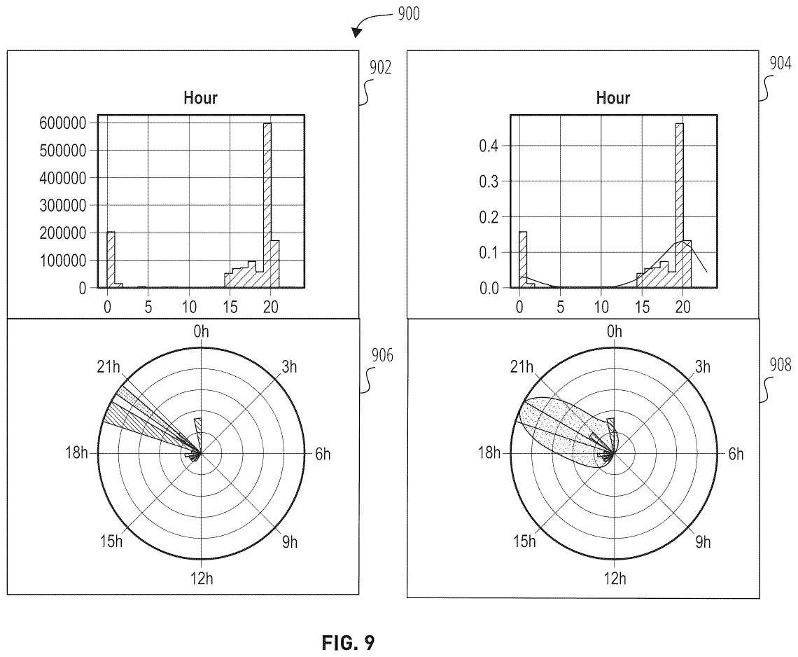

FIG. 5, FIG. 6, FIG. 7, FIG. 8 and FIG. 9 collectively correspond to illustrations of histogram views, periodic mean hour and estimated active period model views for sets of user activities associated with a target customer, as generated by the communication scheduling system 202, according to some examples.

In FIG. 5, given a set of users for a target customer, the communication scheduling system 202 generates aggregated and/or processed user activity data including user event data for the set of users where the user events are “page_viewed” events. Panel 502 illustrates a histogram of the per-time period (e.g., per hour) user event frequencies (the histogram also appears in panel 504). Panel 506 illustrates a circular histogram 510 corresponding to the histogram in panel 502. Panel 506 also illustrates the periodic mean hour 512 computed by the communication scheduling system 202 based on the processed user activity data. Panel 508 illustrates a plot 516 of an estimated active period model using a von Mises kernel, the model being estimated based on the processed user activity data as shown in at least FIG. 2. Plot 516 is overlaid over the circular histogram 514 (e.g., corresponding to circular histogram 510 in panel 506). Panel 504 illustrates a linear version 518 of the plot 516. As can be seen in FIG. 5, there is qualitative evidence that the estimated active period model effectively represents the empirical data (e.g., user activity data).

The user activity data illustrated in panel 602, panel 604, panel 606, and panel 608 of FIG. 6 corresponds to “email_link_clicked” user events for the set of users associated with the selected target customer. Similarly to FIG. 5, FIG. 6 shows qualitative evidence that choosing a von Mises kernel when estimating an active period model based on the “email link clicked” user activity data results in an active period model that effectively represents the respective user activity data.

The user activity data illustrated in panels 702, 704, 706 and 708 of FIG. 7 corresponds to “email_opened” user events for the set of users associated with the selected target customer. FIG. 7 shows qualitative evidence that a von Mises kernel-based active period model estimated based on the “e-mail opened” user activity data as discussed in FIG. 2 effectively represents the respective user activity data.

The user activity data illustrated in panels 802, 804, 806, 808 of FIG. 8 corresponds to “email_delivered” user events for the set of users associated with the selected target customer. FIG. 8 shows qualitative evidence that a von Mises kernel-based active period model estimated based on the “email_delivered” user activity data as discussed in FIG. 2 effectively represents the respective user activity data.

The user activity data illustrated in panels 902, 904, 906, 908 of FIG. 9 corresponds to “sms_delivered” user events for the set of users associated with the selected target customer. FIG. 9 shows qualitative evidence that a von Mises kernel-based active period model estimated based on the user activity data as discussed in FIG. 2 effectively represents the respective user activity data.

FIG. 10 is a block diagram 1000 illustrating a view of a predictive trait system 1020 that includes a framework for creating, training and/or deploying predictive trait models, according to some examples. Predictive trait models are ML models that predict values of traits and/or associated likelihood scores. Traits correspond to user actions, predefined events (e.g., conversion events such as a user purchase or a user click event, events involving one or more user actions), user behaviors, user attributes, and other trait types. Traits or actions can include customer lifetime value (LTV), purchase actions (e.g., for specific objects or types of purchases), repeating purchase actions, customer churn, engagement actions with one or more communication types or specific communications, and so forth. Thus, predicting trait values can refer to computing the likelihood of a user taking- or forgoing-a pre-defined action over a future time period, the likelihood of a pre-defined event taking place during or over a future time period, the likelihood of a particular value for a user behavior or attribute, computing an estimated value of a particular user behavior, attribute or other user-involved trait, and other types of prediction and estimation. The future time period can have a predefined duration (e.g., a specific time interval such as an hour of the 24 hour cycle, one or more of the next Jul. 14, 2030 days, etc.). In a communication scheduling example, the trait of interest can correspond, for example, to user engagement with received communication(s) for users of a selected customer (e.g., customer business). Computing the value of the trait of interest for a target user of the selected customer can refer to computing an optimal time period (e.g., best hour of a 24-hour cycle) to send one or more communications to the target user in order to maximize the likelihood that the target user will engage with the communication (e.g., as described at least in FIG. 2). Computing the value of the trait of interest for the selected customer as a whole can refer to computing individual trait values for each of the users in a set of users associated with the selected customer (e.g., computing optimal send-time periods for members of a customer user base).

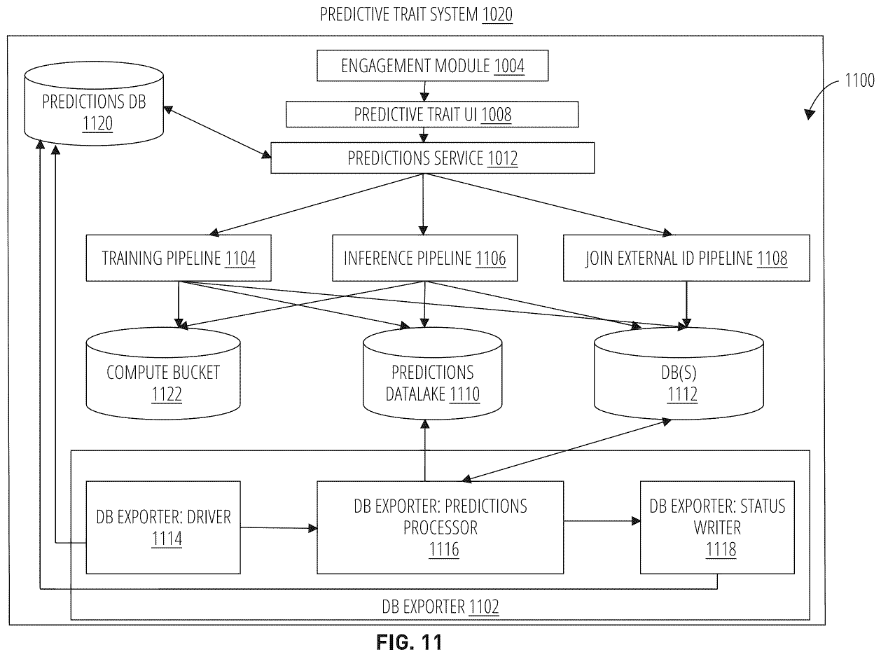

In some examples, predictive trait system 1020 includes one or more of an engagement module 1004, a predictive trait UI 1008 and a predictions service 1012. The engagement module 1004 allows a system user (e.g., a marketer, a business, etc.) to start engaging with the system (e.g., by selecting a prediction user selectable UI element that indicates an interest in using a predictive trait model). The predictive trait UI 1008 includes selectable UI elements that, upon selection by the system user, allow the system user to choose one or more of a set of traits for which to compute a prediction, configure a specific predictive trait, or create and/or configure a new predictive trait. For example, the system user can configure an already selected predictive LTV trait by selecting an “order_completed” event and a “revenue” property (see at least FIG. 11 for details).

Once a trait has been selected, configured and/or created by a system user via the predictive trait UI 1008, the predictive trait UI 1008 executes one or more calls (e.g., API calls) to the predictions service 1012, which is responsible for running pipelines for training and/or estimating trait-specific models and/or pipelines for performing inference using trained and/or estimated trait-specific models.

Predictive trait models can use one or more types of data for constructing/augmenting a training set and/or generating features. Features can be raw features, or transformed and/or aggregated features. In some examples, a trait can have a dedicated feature set. Feature generation can be implemented by a feature generation system. In some examples, features can be derived based on user profiles, explicit and/or provided user attributes and/or categories (e.g., user-provided location or age, user-provided topic interests, etc.), inferred user attributes, categories and/or interests, and/or user behaviors. Data relevant to inferring or capturing user behaviors can include a stream of user-level events and/or actions. Event streams can be expanded to include timestamp information (day of the week, week of the year, month of the year) or activity intervals. In some examples, user profile or user trait data is processed to remove personal identification information (PII).

Given a user-specific event stream, features can include event-stream based features and/or timestamp-related features (e.g., number of page visits in the past K days by a user, average time between page visits in the past K days by a user, time of last page visit by a user in the past K days, etc.). Additional examples of features that capture information such as frequency, recency, trends or ratios derived based on a sequence of recorded events or actions for each user include: number of purchases on day N of the week in the last M weeks, average time between product page views per session, number of clicks on website button B per visit, ratio of cart additions to completed purchases per session, and so forth. Such features can capture frequency or recency information for a set of predefined user events or actions within a predetermined time window. In such cases, the feature generation system relies on a set of predefined user events or actions of interest (e.g., each associated with an ID) and processes a user-specific event stream to compute the features described.

In some examples, the predictive trait system 1020 determines that multiple personas, views, or IDs for an entity (e.g., a user) are associated with a single canonical ID corresponding to the entity (e.g., user). If so, the feature generation system can aggregates feature values for each relevant feature and computes aggregate feature values associated with the canonical ID and/or entity or user. The predictive trait system 1020 can then execute predictions or computations at the level of canonical IDs or entities. For example, the predictive trait system 1020 predicts the likelihood of a future conversion event (such as a click event or purchase event) associated with a canonical ID and/or a group of merged personas/views/IDs.

The predictions service 1012 communicates with an orchestrator 1002 (e.g., a component of the predictive trait system 1020, for instance a Conductor orchestration engine managed by Orkes, or an orchestration engine within any other workflow orchestration platform). The orchestrator 1002 schedules workflows such as onboarding workflow 1010, a training workflow 1014 and an inference workflow 1016. The workflows run one or more processes related to the training, evaluation, and/or deployment of models for predicting selected traits.

In some examples, the onboarding workflow 1010 starts subsequent to the detection, by the orchestrator 1002, of a communication from the predictions service 1012. An example such communication comprises information about a selected and/or configured trait for which to build, evaluate, or deploy a prediction model. The onboarding workflow 1010 can start in response to the predictive trait system 1020 detecting that a system user requests access to the predictive trait UI or predictive trait functionality, for example by engaging with the predictive trait UI 1008 as described above. In some examples, the onboarding workflow 1010 creates a system user (or customer) workspace, used for example to enable database (DB) exports of needed customer data, as detailed in the FIG. 11 discussion. The onboarding workflow 1010 enables a feature flag indicating that the user has access to the predictive trait (or trait prediction) functionality starting at a specific point in time. The onboarding workflow 1010 communicates with the predictions service 1012 to transmit namespace information (e.g., customer information).

In some examples, a training workflow 1014 runs a training process. The training workflow 1014 checks whether it has access to necessary customer data for a given period. The training workflow 1014 creates a training set (e.g., using a compute service 1006) and runs a training pipeline 1104 for a model (e.g., ML model) that computes a prediction for a selected, customized trait (e.g., predicting the likelihood of a future action or conversion event, etc.). The training workflow 1014 can store the data about the members of the training audience (training set) either locally, or in remote storage. The predictive trait system 1020 periodically computes and/or monitors a comprehensive set of metrics to ensure the health of production models, the metrics tracking various stability indicators for model performance over time and over populations or specific characteristics (e.g., a Population Stability Index, a Characteristics Stability Index, etc.). The predictive trait system 1020 uses a set of criteria and operations/decision logic to trigger model retraining, fresh data collection, and/or other steps in order to improve the health of the deployed models. The training workflow 1014 retrains a trained model with fresh data using a time-based schedule and/or a performance-based schedule (e.g., daily/weekly/monthly, etc., triggered by a drop in a periodically-assessed performance of the model, or based on other pre-defined triggering events).

In some examples, the training workflow 1014 can consist of an estimation workflow, for example for estimating (e.g., computing) parameters for a distribution associated with a dataset built from customer data. In some examples, such an estimation workflow can forgo one or more training runs for ML model (as above), and instead use direct estimation of distribution parameters. For example, in a communication scheduling example for one or more users of a given customer, the estimation workflow can implement the user activity data retrieval and/or processing and/or the active period model estimation procedure(s) described in at least FIG. 2. The estimation workflow can re-estimate an active period model for one or more users using a time-based schedule (e.g., every 7 days, monthly, etc.) and/or a performance-based schedule as indicated above.

In some examples, an inference workflow 1016 runs an inference process. The inference workflow 1016 creates an evaluation or test set (e.g., an inference audience). The inference workflow 1016 runs an inference pipeline 1106 and/or a join external ID pipeline 1108. The inference pipeline 1106 retrieves a trained prediction model for a trait and computes prediction results for the trait of interest over the evaluation or test set (e.g., for each customer included in the test set or inference audience). The trait prediction results are synchronized with user profiles and/or specific destinations within an audience destination service 1018. In an example of a communication scheduling scenario, the inference pipeline 1106 can retrieve and/or use one or more estimated active period models computed as described above and/or implement an active period prediction component 212, as described at least in FIG. 2. The inference pipeline 1106 can thus compute, for example, the best time period for communication scheduling/delivery for each target user of the test set of target users associated with the select customer.

Post-inference outputs (e.g., percentiles, stats, other model explainability quantities, null trait values for non-active users) are computed, for example by the join external ID pipeline 1108 (see FIG. 11). Such post-inference outputs are uploaded or synchronized, by the inference workflow 1016 via a sync workflow with audience destination service 1018. Such post-inference outputs correspond to explanations associated with the predictive trait values and/or with the predictive trait model or predictive trait system 1020. The post-inference outputs and/or explanations can be displayed to the system user via one or more UIs, such the predictive trait UI 1008.

FIG. 11 is a block diagram 1100 illustrating a view of a predictive trait system 1020 that includes a framework for creating, training, and/or deploying predictive trait models, according to some examples.

In some examples, predictions service 1012 of a predictive trait system 1020 runs a training pipeline 1104, created for example by a training workflow 1014. The training pipeline 1104 retrieves relevant customer data (e.g., user profile data for members of the training set or training audience, constructed for instance by training workflow 1014), from one or more databases or datalakes such as the predictions datalake 1110, DB(s) 1112, and/or remote storage such as cloud storage. Audience membership data is read or accessed from its local or remote storage. For example, such data is stored by the compute service 1006 in the compute bucket 1122, which corresponds to cloud storage (e.g., AWS storage such as an Amazon S3 bucket, Google Cloud Storage, Microsoft Azure Storage, etc.) The training pipeline assembles the relevant data for each member of the training set (or training audience) by accessing and combining user profile data and audience membership data. In some examples, the training pipeline 1104 reads lean events from the predictions datalake 1110. In some examples, the training pipeline 1104 reads lifetime value (LTV) event properties (e.g., track event properties), and a latest version of merge tables, from one or more DB(s) 1112.

After the training pipeline 1104 retrieves the relevant customer data for the trait of interest and/or the training test of interest, the training pipeline 1104 trains or estimates a new model (e.g., a ML model, a distribution, etc.) corresponding to the trait of interest (e.g, a model for predicting likelihood to purchase, an active period model, etc.). A trained or estimated model for a specific interest can be evaluated by comparing it with a baseline model. If the predictive trait system 1020 automatically assesses that the trained or estimated model meets one or more predetermined performance-related thresholds, the trained or estimated model is used for inference.

The predictions service 1012 runs an inference pipeline 1106 (e.g., as part of the inference workflow 1016) that includes retrieving one or more trained or estimated trait-specific models and/or running the one or more models for corresponding members of a test set or inference audience. In some examples, the same trait-specific model is used for all members of the test set. In some examples, a trained or estimated user-specific model is used for the respective user member of the test set. In some example, the test set is created as part of the inference workflow 1016, using for example a compute service 1006. The test set is stored in local or remote storage (e.g., cloud storage such as cloud compute bucket 1122) for the respective compute service. The test set is accessed (read) by the inference pipeline 1106. In order to run a trained or estimated model on each inference audience member, inference pipeline 1106 assembles the relevant data for each inference audience member (e.g., from predictions datalake 1110, DB(s) 1112, etc.). The inference pipeline 1106 reads lean events (e.g., from predictions datalake 1110), event properties (e.g., for LTV), and/or latest version of merge tables (e.g., from databases 124).

After the inference pipeline 1106 finishes running the one or more relevant models, the predictions service 1012 can run a join external ID pipeline 1108 that joins the results of the inference pipeline (e.g., computed prediction(s) for each member of the inference audience) with external ID tables (e.g., as required by an audience destination service 1018). In some examples, the external ID tables are read from storage such as from one or more DB(s) 1112, etc. The join external ID pipeline 1108 can compute post-inference outputs (e.g., percentiles, stats, model explainability-related quantities, etc.), and/or indicate or mark null trait values for users with low or no activity according to one or more activity-related predetermined thresholds. In some examples, the inference pipeline 1106 and join external ID pipeline 1108 are part of an inference workflow 1016 (see FIG. 10). The inference workflow 1016 can upload predictions (e.g., results of the inference pipeline 1106) to user profiles and/or destinations within an audience destination service 1018.

In some examples, the predictive trait system 1020 includes a DB exporter 1102, which in turn may include a DB exporter: driver 1114, a DB exporter: predictions processor 1116 and a DB exporter: status writer 1118. The DB exporter: driver 1114 triggers an export pipeline (e.g., exporting data from DB(s) 1112) for a given or current customer namespace. The respective export pipeline runs on a schedule (e.g., once a day). The DB exporter 1102, for example via the DB exporter: driver 1114, queries stored customer namespace data, stored for example in the predictions DB 1120. Querying stored customer namespace data includes reading their latest timestamp. The predictive trait system 1020 (e.g., via the DB exporter 1102) also records the creation of a new job. In some examples, the DB exporter: predictions processor 1116 queries customer events and/or traits (e.g., from predictions DB 1120 or DB(s) 1112) incrementally, by date (only new events are processed). In some examples, the DB exporter: predictions processor 1116 exports data to a predictions datalake 1110. In some examples, the DB exporter: status writer 1118 completes the data export process, upserting the latest timestamp for the given or current customer namespace. In some examples, the predictions DB 1120 contains customer namespace information, predictive traits and/or trait values, as well as pipeline and data export states. The information stored in the predictions DB 1120 is retrieved, updated, or augmented by various workflows and/or pipelines as described above.

In some examples, the storage used by the predictive trait system 1020, including the predictions DB 1120, the predictions datalake 1110, DB(s) 1112 and other storage, includes one or more storage types (e.g. Postgres DB, Oracle DB, MySQL DB, Amazon DynamoDB, MongoDB and other relational and non-relational DBs for the predictions DB 1120, an Apache Iceberg (or other solutions for large analytic tables) for predictions datalake 1110, BigQuery for DB(s) 1112, and other storage types.

In some examples, one or more of the pipelines in the predictive trait system 1020 is implemented using a cloud-based machine learning service such as Amazon SageMaker, and a compute service such as AWS Lambda.

Feature Computation and/or Selection Considerations

In some examples, predictive trait system 1020 defines and enforces minimum history requirements for user event streams used to derive features. In some examples, such requirements are based on the set of one or more feature window sizes used during the featurization process. The predictive trait system 1020 employs user inclusion criteria to ensure that target variables and/or features can be computed: for example, users are included in a training set, development set, or user activity dataset used for model estimation if their activity meets a set of predefined thresholds, or based on other automatically tracked measures of user activity, as described, for example, in FIG. 2.

### Model Training and Evaluation Considerations

In some examples, when constructing the entries in the training set and/or evaluation set, the predictive trait system 1020 derives a label for each example in the training/set based on set of binary labels derived from the occurrence of an event during a target window of time. In some examples, the predictive trait system 1020 embeds time information encoded in the event in the label creation process.

In some examples, a predictive trait system 1020 uses criteria, characteristics and/or other information provided by the system user in order to select a subpopulation of interest for model training and/or model estimation. Additional or similar criteria or logic can be implemented by the predictive trait system 1020 to ensure congruence between model training and model inference phases.

In some examples, models trained or estimated by the predictive trait system 1020 are compared against a relevant baseline, using traditional evaluation metrics (e.g., normalized cross entropy, hazard ratio, ROC-AUC, PR-AUC, etc.), or other evaluation metrics. In some examples, a baseline is a univariate scaled score based on most correlated feature/event (extreme feature selection). In some examples, a model is deployed if its performance measured by a single metric is at least as good as the baseline performance and/or a previous trained and/or estimated model.

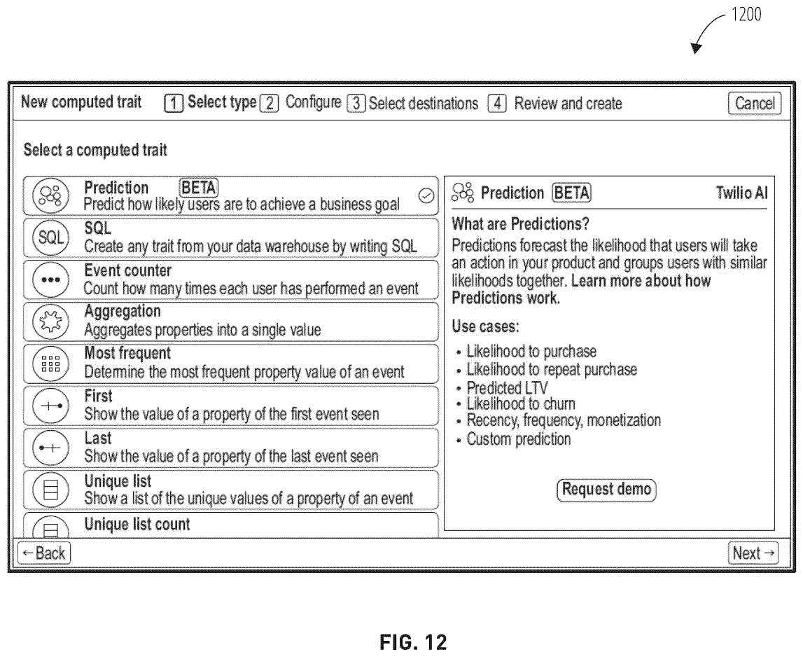

FIG. 12 is an illustration 1200 of a view of a UI for a predictive trait system 1020, according to some examples. In some examples, as part of an onboarding phase, a system user (e.g., marketer) selects one or more user-selectable interface elements in order to choose a “prediction” mode and/or one of a set of traits of interest. In some examples, the system user can request a demo, or fill out a form as part of an onboarding phase.

The predictive trait system 1020 can offer a set of core traits, such as likelihood to purchase, likelihood to repeat purchase, predictive LTV, propensity to churn, and other traits. The predictive trait system 1020 allows the user to create and customize a custom prediction goal, or a custom trait.

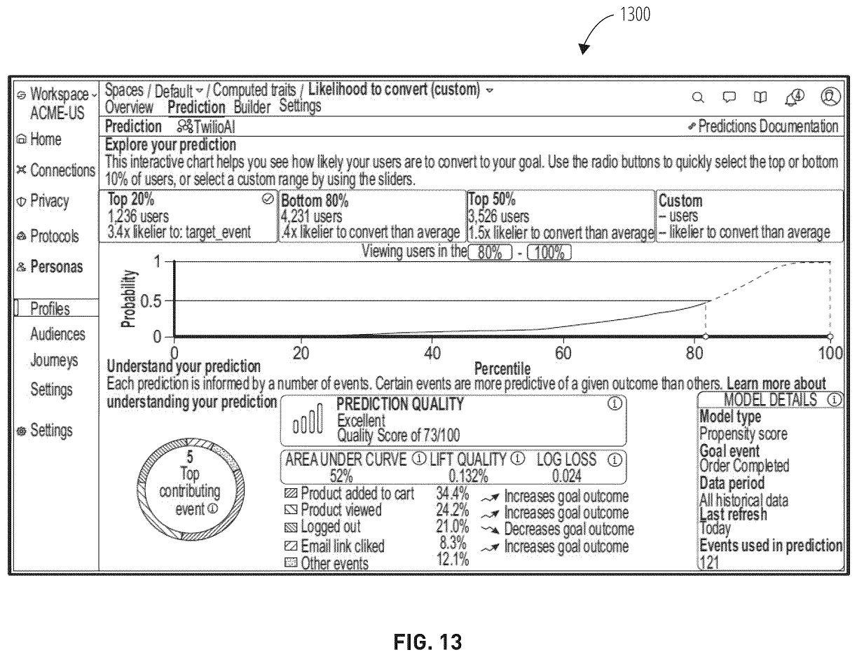

FIG. 13 is an illustration 1300 of a visualization of data related to trait prediction results within a UI for a predictive trait system 1020, according to some examples. In some examples, a system user selects one or more user-selectable UI elements to choose a percentile to build a cohort (top K % users ranked by the probability that they will undertake the desired action, or convert to the marketer goal expressed for example as a target_event). In some examples, the predictive trait system 1020 includes additional visualizations, such as for example a visualization of historical trait values, for example based on various aggregation functions or statistics computed over the population of users for which historical trait-related data is available, etc. In some examples, a visualization of historical trait values for only certain users of interest is be included.

In some examples, a UI for the predictive trait system 1020 can include a visualization of the change in the trait prediction values (e.g., propensity scores, most likely hourly period for communication scheduling, etc.) for one or more users (e.g., people in the set a customer is interested in). A user's trait prediction value can change periodically (e.g., weekly) based on the user's actions (e.g., interacting with one or more tracked websites, opening received marketing communications, etc.). A visualization displayed within a UI for the predictive trait system 1020 can show the overall trait prediction value for a set of people periodically changing (e.g., on a weekly basis): an average score for a user population (e.g., the average score varying over time), or track an collective measure of propensity scores (e.g., the propensity to purchase over time) as they change periodically (e.g., from week to week), based on new propensity scores) being computed. In some examples, percentile-level changes (e.g., changes in the top 10% cohort, bottom 10%, etc.) can be visualized. In some examples, visualizations use a min-max candle view.

In some examples, a UI for a predictive trait system 1020 includes selected information about trait usage (particular steps in audience construction, journeys, etc.), trait growth and more. In some examples, the UI includes a visualization of data pertaining to the training and/or estimation and/or evaluation of the trait-specific model (e.g., feature information, feature weights, estimated distribution parameters for an active period model, a score indicating prediction quality and other information pertaining to explainable AI-type functions or modules).

The user UI can also include data collection guidelines (either embedded in the UI or available in linked documentation) for customers, in order to improve quality and impact of the predictive trait models.

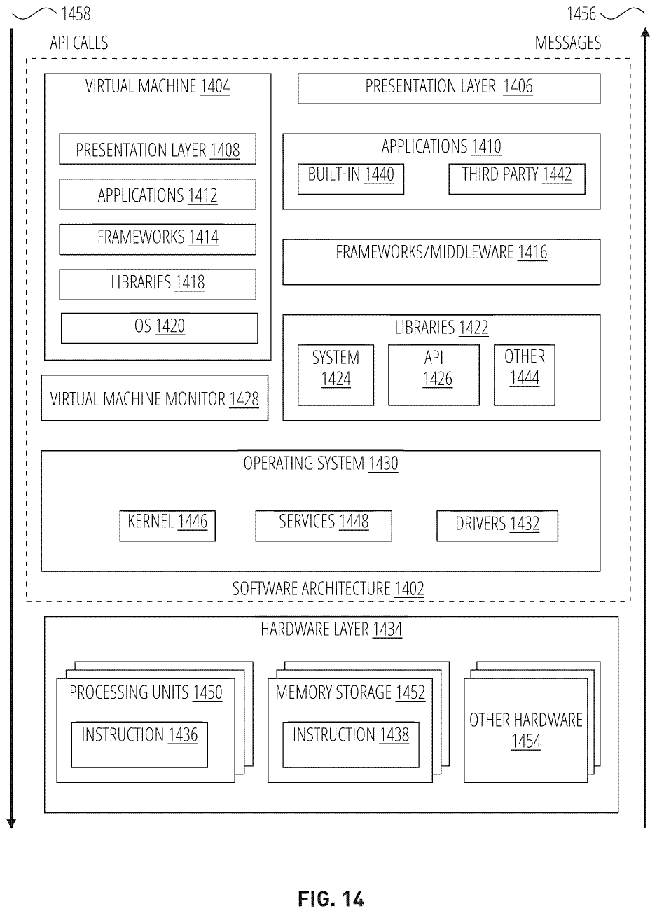

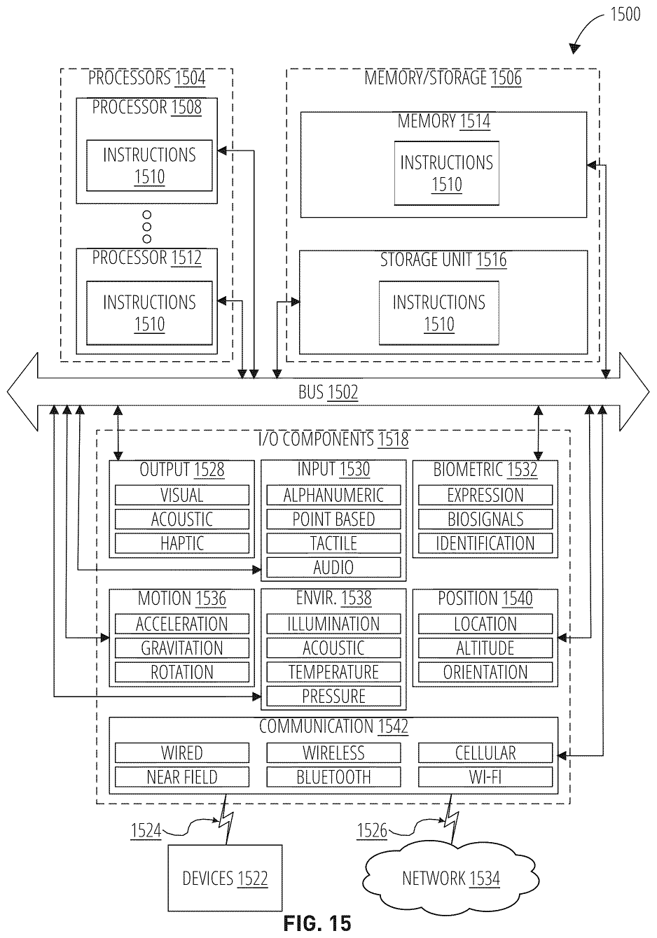

FIG. 14 is a block diagram illustrating an example of a software architecture 1402 that may be installed on a machine, according to some example embodiments. FIG. 14 is merely a non-limiting example of software architecture, and it will be appreciated that many other architectures may be implemented to facilitate the functionality described herein. The software architecture 1402 may be executing on hardware such as a machine 1500 of FIG. 15 that includes, among other things, processors 1504, memory/storage 1506, and input/output (I/O) components 1518. A representative hardware layer 1434 is illustrated and can represent, for example, the machine 1500 of FIG. 15. The representative hardware layer 1434 comprises one or more processing units 1450 having associated executable instructions 603. The executable instructions 603 represent the executable instructions of the software architecture 1402. The hardware layer 1434 also includes memory or storage 1052, which also have the executable instructions 1436. The hardware layer 1434 may also comprise other hardware 1454, which represents any other hardware of the hardware layer 1434, such as the other hardware illustrated as part of the machine 1500.

In the example architecture of FIG. 14, the software architecture 1402 may be conceptualized as a stack of layers, where each layer provides particular functionality. For example, the software architecture 1402 may include layers such as an operating system 1430, libraries 1418, frameworks/middleware 1416, applications 1410, and a presentation layer 1408. Operationally, the applications 1410 or other components within the layers may invoke API calls 1458 through the software stack and receive a response, returned values, and so forth (illustrated as messages 1456) in response to the API calls 1458. The layers illustrated are representative in nature, and not all software architectures have all layers. For example, some mobile or special-purpose operating systems may not provide a frameworks/middleware 1416 layer, while others may provide such a layer. Other software architectures may include additional or different layers.

The operating system 1430 may manage hardware resources and provide common services. The operating system 1430 may include, for example, a kernel 1446, services 1448, and drivers 1032. The kernel 1446 may act as an abstraction layer between the hardware and the other software layers. For example, the kernel 1446 may be responsible for memory management, processor management (e.g., scheduling), component management, networking, security settings, and so on. The services 1448 may provide other common services for the other software layers. The drivers 1432 may be responsible for controlling or interfacing with the underlying hardware. For instance, the drivers 1032 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 1418 may provide a common infrastructure that may be utilized by the applications 1410 and/or other components and/or layers. The libraries 1418 typically provide functionality that allows other software modules to perform tasks in an easier fashion than by interfacing directly with the underlying operating system 1430 functionality (e.g., kernel 1446, services 1448, or drivers 1032). The libraries 1418 (or libraries 1422) may include system libraries 1424 (e.g., C standard library) that may provide functions such as memory allocation functions, string manipulation functions, mathematic functions, and the like. In addition, the libraries 1418 may include API libraries 1426 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 1418 or libraries 1422 may also include a wide variety of other libraries 1444 to provide many other APIs to the applications 1410 and other software components/modules.

The frameworks 1414 (also sometimes referred to as middleware) may provide a higher-level common infrastructure that may be utilized by the applications 1410 or other software components/modules. For example, the frameworks 1414 may provide various graphical user interface functions, high-level resource management, high-level location services, and so forth. The frameworks 1414 may provide a broad spectrum of other APIs that may be utilized by the applications 1410 and/or other software components/modules, some of which may be specific to a particular operating system or platform.

The applications 1410 include built-in applications and/or third-party applications 642. Examples of representative built-in applications 1440 may include, but are not limited to, a home application, a contacts application, a browser application, a book reader application, a location application, a media application, a messaging application, or a game application.

The third-party applications 1442 may include any of the built-in applications 1440, as well as a broad assortment of other applications. In a specific example, the third-party applications 1442 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 1442 may invoke the API calls 1458 provided by the mobile operating system such as the operating system 1430 to facilitate functionality described herein.

The applications 1410 may utilize built-in operating system functions, libraries (e.g., system libraries 1424, API libraries 1426, and other libraries 1444), or frameworks/middleware 1416 to create user interfaces to interact with users of the system. Alternatively, or additionally, in some systems, interactions with a user may occur through a presentation layer, such as the presentation layer 1408. In these systems, the application/module “logic” can be separated from the aspects of the application/module that interact with the user.

Some software architectures utilize virtual machines. In the example of FIG. 14, this is illustrated by a virtual machine 1404. The virtual machine 1404 creates a software environment where applications/modules can execute as if they were executing on a hardware machine. The virtual machine 1404 is hosted by a host operating system (e.g., the operating system 1430) and typically, although not always, has a virtual machine monitor 1428, which manages the operation of the virtual machine 1404 as well as the interface with the host operating system (e.g., the operating system 1430). A software architecture executes within the virtual machine 1404, such as an operating system 1430, libraries 1418, frameworks/middleware 1416, applications 1412, or a 1408. These layers of software architecture executing within the virtual machine 1404 can be the same as corresponding layers previously described or may be different.

FIG. 15 is a block diagram illustrating components of a machine 1500, according to some example embodiments, able to read instructions from a machine-readable medium (e.g., a machine-readable storage medium) and perform any one or more of the methodologies discussed herein. Specifically, FIG. 15 shows a diagrammatic representation of the machine 1500 in the example form of a computer system, within which instructions 1510 (e.g., software, a program, an application, an applet, an app, or other executable code) for causing the machine 1500 to perform any one or more of the methodologies discussed herein may be executed. As such, the instructions 1510 may be used to implement modules or components described herein. The instructions 1510 transform the general, non-programmed machine 1500 into a particular machine 1500 to carry out the described and illustrated functions in the manner described. In alternative embodiments, the machine 1500 operates as a standalone device or may be coupled (e.g., networked) to other machines. In a networked deployment, the machine 1500 may operate in the capacity of a server machine or a client machine in a server-client network environment, or as a peer machine in a peer-to-peer (or distributed) network environment. The machine 1500 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, a wearable device (e.g., a smart watch), other smart devices, a web appliance, a network router, a network switch, a network bridge, or any machine capable of executing the instructions 1510, sequentially or otherwise, that specify actions to be taken by machine 1500. Further, while only a single machine 1500 is illustrated, the term “machine” shall also be taken to include a collection of machines that individually or jointly execute the instructions 1510 to perform any one or more of the methodologies discussed herein.

The machine 1500 may include processors 1504, memory/storage 1506, and I/O components 1518, which may be configured to communicate with each other such as via a bus 1502. The memory/storage 1506 may include a memory 1514, such as a main memory, or other memory storage, and a storage unit 1516, both accessible to the processors 1504 such as via the bus 1502. The storage unit 1516 and memory 1514 store the instructions 1510 embodying any one or more of the methodologies or functions described herein. The instructions 1510 may also reside, completely or partially, within the memory 1514 within the storage unit 1516, within at least one of the processors 1504 (e.g., within the processor's cache memory), or any suitable combination thereof, during execution thereof by the machine 1500. Accordingly, the memory 1514, the storage unit 1516, and the memory of processors 1504 are examples of machine-readable media.

The I/O components 1518 may include a wide variety of components to receive input, provide output, produce output, transmit information, exchange information, capture measurements, and so on. The specific I/O components 1518 that are included in a particular machine 1500 will depend on the type of machine. For example, portable machines such as mobile phones will likely include a touch input device or other such input mechanisms, while a headless server machine will likely not include such a touch input device. It will be appreciated that the I/O components 1518 may include many other components that are not shown in FIG. 11. The I/O components 1518 are grouped according to functionality merely for simplifying the following discussion and the grouping is in no way limiting. In various example embodiments, the I/O components 1518 may include output components 1528 and input components 1530. The output components 1528 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1530 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

In further example embodiments, the I/O components 1518 may include biometric components 1532, motion components 1536, environmental environment components 1538, or position components 1540 among a wide array of other components. For example, the biometric components 1532 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1536 may include acceleration sensor components (e.g., accelerometer), gravitation sensor components, rotation sensor components (e.g., gyroscope), and so forth. The environment components 1538 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 1540 may include location sensor components (e.g., a Global Position system (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1518 may include communication components 1542 operable to couple the machine 1500 to a network 1534 or devices 1522 via coupling 1524 and coupling 1526 respectively. For example, the communication components 1542 may include a network interface component or other suitable device to interface with the network 1534. In further examples, communication components 1542 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1522 may be another machine or any of a wide variety of peripheral devices (e.g., a peripheral device coupled via a Universal Serial Bus (USB)).

Moreover, the communication components 1542 may detect identifiers or include components operable to detect identifiers. For example, the communication components 1542 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1542, such as, location via Internet Protocol (IP) geo-location, location via Wi-Fi® signal triangulation, location via detecting a NFC beacon signal that may indicate a particular location, and so forth.

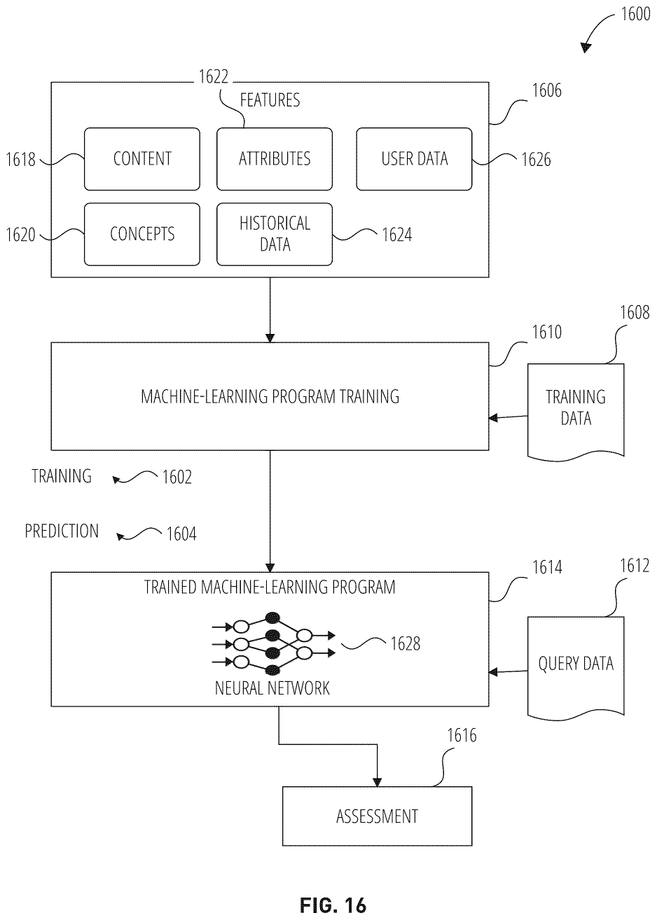

FIG. 16 is a block diagram showing a machine-learning program 1600 according to some examples. The machine-learning programs 1600, also referred to as machine-learning algorithms or tools, are used as part of the predictive trait system 1020 system described herein, for instance to perform operations of trait-specific machine learning models (see FIG. 10 and FIG. 11).

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 1608 in order to make data-driven predictions or decisions expressed as outputs or assessments (e.g., assessment 1616). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 1600 supports two types of phases, namely a training phases 1602 and prediction phases 1604. In training phases 1602, supervised learning, unsupervised or reinforcement learning may be used. For example, the machine-learning program 1600 (1) receives features 1606 (e.g., as structured or labeled data in supervised learning) and/or (2) identifies features 1606 (e.g., unstructured or unlabeled data for unsupervised learning) in training data 1608 In prediction phases 1604, the machine-learning program 1600 uses the features 1606 for analyzing query data 1612 to generate outcomes or predictions, as examples of an assessment 1616.

In the training phase 1602, feature engineering is used to identify features 1606 and may include identifying informative, discriminating, and independent features for the effective operation of the machine-learning program 1600 in pattern recognition, classification, and regression. In some examples, the training data 1608 includes labeled data, which is known data for pre-identified features 1606 and one or more outcomes. Each of the features 16066 may be a variable or attribute, such as individual measurable property of a process, article, system, or phenomenon represented by a data set (e.g., the training data 1608). Features 1606 may also be of different types, such as numeric features, strings, and graphs, and may include one or more of content 1618, concepts 1620, attributes 1622, historical data 1624 and/or user data 1626, merely for example.

In training phases 1602, the machine-learning program 1600 uses the training data 1608 to find correlations among the features 1606 that affect a predicted outcome or assessment 1616

With the training data 1608 and the identified features 1606, the machine-learning program 1600 is trained during the training phase 1602 at machine-learning program training 1610. The machine-learning program 1600 appraises values of the features 1606 as they correlate to the training data 1608. The result of the training is the trained machine-learning program 1614 (e.g., a trained or learned model).

Further, the training phases 1602 may involve machine learning, in which the training data 1608 is structured (e.g., labeled during preprocessing operations), and the trained machine-learning program 1614 implements a relatively simple neural network 1628 (or one of other machine learning models, as described herein) capable of performing, for example, classification and clustering operations. In other examples, the training phase 1602 may involve deep learning, in which the training data 1608 is unstructured, and the trained machine-learning program 1614 implements a deep neural network 1628 that is able to perform both feature extraction and classification/clustering operations.

A neural network 1628 generated during the training phase 1602, and implemented within the trained machine-learning program 1614, may include a hierarchical (e.g., layered) organization of neurons. For example, neurons (or nodes) may be arranged hierarchically into a number of layers, including an input layer, an output layer, and multiple hidden layers. The layers within the neural network 1628 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 1628 may also be one of a number of different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

During prediction phases 1604 the trained machine-learning program 1614 is used to perform an assessment. Query data 1612 is provided as an input to the trained machine-learning program 1614, and the trained machine-learning program 1614 generates the assessment 1616 as output, responsive to receipt of the query data 1612.

In some examples, the trained machine-learning program 1614 may be a generative artificial intelligence (AI) model. Generative AI is a term that may refer to any type of artificial intelligence that can create new content from training data 1608. For example, generative AI can produce text, images, video, audio, code, or synthetic data similar to the original data but not identical.

Some of the techniques that may be used in generative AI are:
1. Convolutional Neural Networks (CNNs): CNNs may be used for image recognition and computer vision tasks. CNNs may, for example, be designed to extract features from images by using filters or kernels that scan the input image and highlight important patterns.
2. Recurrent Neural Networks (RNNs): RNNs may be used for processing sequential data, such as speech, text, and time series data, for example. RNNs employ feedback loops that allow them to capture temporal dependencies and remember past inputs.
3. Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
4. Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
5. Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data include predictions, translations, summaries or media content.

In some generative AI examples, the trained machine-learning program 1614 can be a Large Language Model (LLM). LLMs can perform tasks such as recognizing, translating, predicting, or generating text (or other content), and can be used for text classification, question answering, document summarization, text generation, as well as plan generation, code generation, prediction problems (e.g., predicting protein structures), and so forth. Examples of LLMs include GPT-3.5, GPT-4, Bard, Cohere, PaLM, Falcon, Claude, Llama, Orca, Phi-1, Jurassic and more.

### EXAMPLES

Example 1 is a system comprising: at least one processor; at least one memory component storing instructions that, when executed by the at least one processor, cause the at least one processor to perform operations comprising: accessing, for each user of a set of users, user activity data comprising one or more user events; processing, for each user of the set of users, the user activity data to generate processed activity data; estimating, for each user of the set of users, an active period model based on the processed user activity data and a constraint configuration; computing, for each user of the set of users and using the active period model for the user, activity scores for candidate time periods; selecting, for each user of the set of users, at least one time period of the candidate time periods based on the activity scores for the user; and transmitting, for each user of the users, a communication to the user during the selected at least one time period.

In Example 2, the subject matter of Example 1 includes, wherein processing the user activity data further comprises filtering the user activity data based on one or more of: time period inclusion or exclusion properties in the constraint configuration, and activity quantity requirements comprising one or more of at least a predetermined minimum period of user activity, a predetermined maximum period of user activity, or a predetermined minimum number of user events.

In Example 3, the subject matter of Examples 1-2 includes, wherein processing the user activity data further comprises filtering out user events corresponding to communications detected to be opened by proxy servers.

In Example 4, the subject matter of Examples 1-3 includes, wherein estimating the active period model further comprises: selecting a distribution based on one or more constraints in the constraint configuration; computing parameters of the selected distribution based on the processed user activity data.

In Example 5, the subject matter of Example 4 includes, wherein: the constraint configuration specifies one or more time-associated constraints; the selected distribution is a von Mises distribution; and the parameters comprise a location parameter corresponding to a periodic mean, and a shape parameter indicating a concentration of data around the periodic mean.

In Example 6, the subject matter of Examples 4-5 includes, selecting a kernel density estimation technique with a kernel function; estimating a probability density function as a sum of kernel functions centered at data points of the processed user activity data.

In Example 7, the subject matter of Example 6 includes, wherein the kernel function corresponds to a von Mises distribution kernel.

In Example 8, the subject matter of Examples 4-7 includes, wherein computing the activity scores for the candidate time periods for each user of the set of users further comprises using the selected distribution and the estimated parameters to compute a probability of user activity for each candidate time period of the candidate time periods.

In Example 9, the subject matter of Examples 1-8 includes, wherein selecting, for each user of the set of users, the at least one time period further comprises: ranking the computed activity scores associated with the candidate time periods based on a predetermined ranking criterion; determining a set of highest ranked activity scores and one or more associated candidate time periods based on a predetermined set size; and selecting the one or more associated candidate time periods.

In Example 10, the subject matter of Examples 1-9 includes, a predictive trait user interface (UI), and wherein: the accessing of user event data for the set of users is responsive to detecting, at the predictive trait UI, a selection of a predictive trait corresponding to engagement with a communication for users of a customer business; and computing a value of the predictive trait for each user of the set of users corresponds to the selecting, for each user of the set of users, of the at least one time period based on the activity scores for the user.

In Example 11, the subject matter of Example 10 includes, displaying, at the predictive trait UI, explanations computed based on one or more of at least the computed predictive trait values and the set of users, the explanations comprising at least a visualization of computed predictive trait values.

Example 12 is at least one non-transitory machine-readable medium (or computer-readable medium) including instructions that, when executed by processing circuitry, cause the processing circuitry to perform operations to implement of any of Examples 1-11.

Example 13 is an apparatus comprising means to implement any of Examples 1-11.

Example 14 is a system to implement any of Examples 1-11.

Example 15 is a method to implement any of Examples 1-11.

### Glossary

“CARRIER SIGNAL” in this context refers to any intangible medium that is capable of storing, encoding, or carrying instructions for execution by the machine, and includes digital or analog communications signals or other intangible medium to facilitate communication of such instructions. Instructions may be transmitted or received over the network using a transmission medium via a network interface device and using any one of a number of well-known transfer protocols.

“CLIENT DEVICE” in this context refers to any machine that interfaces to a communications network to obtain resources from one or more server systems or other client devices. A client device may be, but is not limited to, a mobile phone, desktop computer, laptop, portable digital assistants (PDAs), smart phones, tablets, ultra books, netbooks, laptops, multi-processor systems, microprocessor-based or programmable consumer electronics, game consoles, set-top boxes, or any other communication device that a user may use to access a network.

“COMMUNICATIONS NETWORK” in this context refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“MACHINE-READABLE MEDIUM” in this context refers to a component, device or other tangible media able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions. The term “machine-readable medium” shall also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT” in this context refers to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some example embodiments, the processors or processor-implemented components may be located in a single geographic location (e.g., within a home environment, an office environment, or a server farm). In other example embodiments, the processors or processor-implemented components may be distributed across a number of geographic locations.

“PROCESSOR” in this context refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“TIMESTAMP” in this context refers to a sequence of characters or encoded information identifying when a certain event occurred, for example giving date and time of day, sometimes accurate to a small fraction of a second.

“TIME DELAYED NEURAL NETWORK (TDNN)” in this context, a TDNN is an artificial neural network architecture whose primary purpose is to work on sequential data. An example would be converting continuous audio into a stream of classified phoneme labels for speech recognition.

“BI-DIRECTIONAL LONG-SHORT TERM MEMORY (BLSTM)” in this context refers to a recurrent neural network (RNN) architecture that remembers values over arbitrary intervals. Stored values are not modified as learning proceeds. RNNs allow forward and backward connections between neurons. BLS™ are well-suited for the classification, processing, and prediction of time series, given time lags of unknown size and duration between events.

“TRAINING SET” and “TEST SET” in this context are understood in the context of typical ML model development. A development set is selected and properly split into train/validation/test sets. The training set may refer to a “train/validation” set. The test set may refer to a “test/evaluation” or “test/assessment” set. In some examples, properly splitting the development set takes into account temporal dependencies, for example corresponding to the time series nature of the event streams, or the tracked user behaviors.

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
at least one processor;
at least one memory component storing instructions that, when executed by the at least one processor, cause the at least one processor to perform operations comprising:
accessing, for each user of a set of users, user activity data comprising one or more user events;
processing, for each user of the set of users, the user activity data to generate processed activity data;
estimating, for each user of the set of users, an active period model based on the processed user activity data and a constraint configuration;
computing, for each user of the set of users and using the active period model for the user, activity scores for candidate time periods;
selecting, for each user of the set of users, at least one time period of the candidate time periods based on the activity scores for the user; and
transmitting, for each user of the users, a communication to the user during the selected at least one time period.

2. The system of claim 1, wherein processing the user activity data further comprises filtering the user activity data based on one or more of:
time period inclusion or exclusion properties in the constraint configuration, and
activity quantity requirements comprising one or more of at least a predetermined minimum period of user activity, a predetermined maximum period of user activity, or a predetermined minimum number of user events.

3. The system of claim 1, wherein processing the user activity data further comprises filtering out user events corresponding to communications detected to be opened by proxy servers.

4. The system of claim 1, wherein estimating the active period model further comprises:
selecting a distribution based on one or more constraints in the constraint configuration;
computing parameters of the selected distribution based on the processed user activity data.

5. The system of claim 4, wherein:
the constraint configuration specifies one or more time-associated constraints;
the selected distribution is a von Mises distribution; and
the parameters comprise a location parameter corresponding to a periodic mean, and a shape parameter indicating a concentration of data around the periodic mean.

6. The system of claim 4, further comprising:
selecting a kernel density estimation technique with a kernel function;
estimating a probability density function as a sum of kernel functions centered at data points of the processed user activity data.

7. The system of claim 6, wherein the kernel function corresponds to a von Mises distribution kernel.

8. The system of claim 4, wherein computing the activity scores for the candidate time periods for each user of the set of users further comprises using the selected distribution and the estimated parameters to compute a probability of user activity for each candidate time period of the candidate time periods.

9. The system of claim 1, wherein selecting, for each user of the set of users, the at least one time period further comprises:
ranking the computed activity scores associated with the candidate time periods based on a predetermined ranking criterion;
determining a set of highest ranked activity scores and one or more associated candidate time periods based on a predetermined set size; and
selecting the one or more associated candidate time periods.

10. The system of claim 1, further comprising a predictive trait user interface (UI), and wherein:
the accessing of user event data for the set of users is responsive to detecting, at the predictive trait UI, a selection of a predictive trait corresponding to engagement with a communication for users of a customer business; and
computing a value of the predictive trait for each user of the set of users corresponds to the selecting, for each user of the set of users, of the at least one time period based on the activity scores for the user.

11. The system of claim 10, further comprising displaying, at the predictive trait UI, explanations computed based on one or more of at least the computed predictive trait values and the set of users, the explanations comprising at least a visualization of computed predictive trait values.

12. A computer-implemented method, comprising:
accessing, for each user of a set of users, user activity data comprising one or more user events;
processing, for each user of the set of users, the user activity data to generate processed activity data;
estimating, for each user of the set of users, an active period model based on the processed user activity data and a constraint configuration;
computing, for each user of the set of users and using the active period model for the user, activity scores for candidate time periods;
selecting, for each user of the set of users, at least one time period of the candidate time periods based on the activity scores for the user; and
transmitting, for each user of the users, a communication to the user during the selected at least one time period.

13. The computer-implemented method of claim 12, wherein processing the user activity data further comprises filtering the user activity data based on one or more of:
time period inclusion or exclusion properties in the constraint configuration, and
activity quantity requirements comprising one or more of at least a predetermined minimum period of user activity, a predetermined maximum period of user activity, or a predetermined minimum number of user events.

14. The computer-implemented method of claim 12, wherein processing the user activity data further comprises filtering out user events corresponding to communications detected to be opened by proxy servers.

15. The computer-implemented method of claim 12, wherein estimating the active period model further comprises:
selecting a distribution based on one or more constraints in the constraint configuration;
computing parameters of the selected distribution based on the processed user activity data.

16. The computer-implemented method of claim 15, wherein:
the constraint configuration specifies one or more time-associated constraints;
the selected distribution is a von Mises distribution; and
the parameters comprise a location parameter corresponding to a periodic mean, and a shape parameter indicating a concentration of data around the periodic mean.

17. The computer-implemented method of claim 15, further comprising:
selecting a kernel density estimation technique with a kernel function;
estimating a probability density function as a sum of kernel functions centered at data points of the processed user activity data.

18. The computer-implemented method of claim 17, wherein the kernel function corresponds to a von Mises distribution kernel.

19. The computer-implemented method of claim 15, wherein computing the activity scores for the candidate time periods for each user of the set of users further comprises using the selected distribution and the estimated parameters to compute a probability of user activity for each candidate time period of the candidate time periods.

20. A non-transitory computer-readable storage medium, the computer-readable storage medium including instructions that when executed by a computer, cause the computer to:
access, for each user of a set of users, user activity data comprising one or more user events;
process, for each user of the set of users, the user activity data to generate processed activity data;
estimate, for each user of the set of users, an active period model based on the processed user activity data and a constraint configuration;
compute, for each user of the set of users and using the active period model for the user, activity scores for candidate time periods;
select, for each user of the set of users, at least one time period of the candidate time periods based on the activity scores for the user; and
transmit, for each user of the users, a communication to the user during the selected at least one time period.
